(19) United States
(12) Patent Application Publication
(10) Pub. No.: US 2013/0032437 A1
(43) Pub. Date: Feb. 7, 2013

(54) Internal Ventilation Diaphragm Piston Brake Actuator

(71) Applicants: Ahmet Akin, Gebze (TR); Yavuz Battal, Gebze (TR); Cuneyt Tengerli, Gebze (TR)

(72) Inventors: Ahmet Akin, Gebze (TR); Yavuz Battal, Gebze (TR); Cuneyt Tengerli, Gebze (TR)

(73) Assignee: Arfesan Arkan Fren Elemanlari Sanayi ve Ticaret A.S., Gebze, Kocaeli (TR)

(21) Appl. No.: 12/811,523

(22) PCT Filed: Jan. 2, 2009
(86) PCT No.: PCT/TR2009/000001

§ 371 Date: Nov. 26, 2011

(30) Foreign Application Priority Data
Jan. 2, 2008 (TR) 2008/00007

(51) Int. Cl. B60T 13/38

(52) U.S. Cl. 188/106 F

(57) ABSTRACT

This invention is related to the decrease of the breakdowns that occur in the actuators by means of the application of internal ventilation system to the diaphragm piston spring brake actuators which are used in vehicles such as truck, van, bus and trailer. The internally ventilated diaphragm-piston spring brake actuator that is developed by this invention is comprised by an aluminum piston, an aluminum pipe, a park chamber, a service chamber, a piston valve (6), a piston valve spring (7), inlet air openings (11), an air transition space, a plug (13), air inlet holes, a pneumatic sealing, an outlet channel characterized in that it has a valve (26) having sealing lips (27), sealing surface of piston valve (28) and a square or rectangular sectioned sealing member.

### FIELD OF INVENTION

This invention is related to diaphragm-piston spring brake actuators which are used in heavy vehicles such as trucks, busses and trailers. This invention is developed with an aim to internal ventilation system that is used in diaphragm piston type spring brake actuators that are the subject of Patent Application No. TR 2002 00761 U and PCT Application No. WO 03/080417. The internal ventilation system briefly refers to a system that avoids the factors such as dust, dirt and moisture which may affect the operation of the actuator from the back part of the piston by isolating the said part from the outer environment.

Spring brake actuator consist of the service chamber that is activated during normal driving conditions; and park chamber which is turned to be activated in case of an air leakage or deliberate release of the air (pulling the handbrake). When it is requested to slow down or stop the vehicle, the service chamber is activated whereas the parking chamber is used when the vehicle is fixed. In other words, when force is applied to the foot brake of the vehicle, the service chamber and when the force is applied to the handbrake, the parking chamber is operated.

### PRIOR ART

In the traditional diaphragm-piston spring brake actuators produced by the known technique, an external connection called as breather tube (4) is used for transferring the compressed and expanded air at the back part of the piston during the forward and backward motion of the piston (1) in the (a) and (b) directions and thereby decreasing the effect of the mentioned air (FIG. 1).

The breather tube (4) in the traditional diaphragm-piston spring brake actuators produced by the known technique is attached to the housings by means of the rubber connection components which are named as rubber elbow (20 and 21). During the motion of the piston (1) in (b) direction, air is absorbed into the back part (18) of the piston from the atmospheric area (19) by means of the breather tube (4). Atmospheric area is opened to the external environment through the ventilation hole. In addition to the air, dust and moisture could easily enter through the said ventilation hole. Dust and moisture is carried to the back part of the piston via the breather tube (4) by the movement of the piston (1) in (b) direction. Particularly moisture results in corrosion in the emergency spring (25); and dust damages the pneumatic sealing elements (22) and the sliding ring (23) over time.

Moreover, rubber elbows (20, 21) are damaged by being affected by the atmospheric conditions in time; and these connections would loosen. Simultaneously, it is frequently encountered that any end of the breather tube (4) open to the atmosphere as a result of any possible damages on the said connection by means of the vibration or the splashing stones from the road. In case that the said connections are damaged, water and mud would break into the back part (18) of the piston and cause the corrosion of the sliding ring (23) and the sealing member (22); and failure in the sealing. In addition, intrusive water and corrosive materials may cause damage to the emergency spring (25) that is responsible for holding the vehicle at parking condition. In this case, it would require the urgent necessity for the repair or replace of the spring brake actuator having a vital importance.

Internal ventilation systems were designed to operate the diaphragm piston spring brake actuators without being affected by the above mentioned factors. Internal ventilation systems isolate the parking chamber of the actuators completely from the atmosphere and entrance of the contaminant materials into the back part of the piston (1) is avoided. The back part (18) of the piston is ventilated by means of the dry air existing in the air system of the vehicle. Therefore, this system eliminates the possibility of any breakdown in the actuator due to the external contaminants or humid air.

In the Patent Application No. TR 2002 00761 U and PCT Application No. WO 03/080417 A1, it is disclosed an internal ventilation system that is developed by our firm for the diaphragm piston spring brake actuators. FIG. 2 demonstrates a spring brake actuator wherein the internal ventilation system is applied; and FIGS. 3 and 4 depict the cross section of the mechanisms belonging to the internal ventilation system.

Internal ventilation system operates briefly as follows: By the sending of the air into the park chamber (3), the said park chamber (3) is filled with the pressurized air received from the air tanks of the vehicle. In this case, steel ball (9) of the piston valve (6) compresses the spring (7) by the effect of the pressure and fits on the O-Ring (8). Thus, the piston valve (6) is shut and sealing is ensured. Due to the pressure created in the park chamber (3), the piston (1) moves in (a) direction; and compresses the air at the back part (18) of the piston. Compressed air passes through the air transition aperture (24) and reaches at the plug (13). Air enters into the plug (13) through the air inlet openings (14); and arrives at the outlet channel (16) by opening the pneumatic sealing (15). Compressed air enables the o-ring (17) being opened; and releases into the service chamber (5). Meanwhile, compressed air is also released to the atmosphere as the service chamber (5) is open to the atmosphere over various valves differing from system to system.

By the release of the air in the park chamber (3) when the vehicle switches into the parking condition; the piston (1) moves in (b) direction by the force created by the emergency spring (25); and results in a partial vacuum at the back part (18) of the piston (1). The said vacuum is opened to the atmosphere by means of a piston valve (6). In other words, the pressure which is effective on the ball (9) rapidly decreases towards the atmospheric pressure by the release of the air inside the park chamber (3). Simultaneously, the ball (9) leaves from the o-ring (8) situated on its top through its motion exerted by the force supported by the compressed spring (7). Area of the back part (18) of the piston reaches atmospheric pressure through absorbed air from air transition space (12) with this motion.

### OBJECTIVES FOR THE DEVELOPMENT OF THE INVENTION

The internal ventilation system developed by this invention aims to;
prevent the entrance of the factors such as dust, dirt, stone and moisture which would affect the operation of the actuator into the back part (18) of the piston;
isolate the back part (18) of the piston completely from the external environment;
prevent the corrosion of the emergency spring (25);
prevent the corrosion of the sealing member (22) and the sliding ring (23);
arrange the closing pressure of the piston valve (6) at a more compatible level;
increase the safety by using a sealing member (29) with a larger section on the plug (13)

### DESCRIPTION OF THE FIGURES

The description of the figures which are prepared in order to better explain the internally ventilated diaphragm-piston spring brake actuators which has been developed with this invention and of the brake actuators which have been developed by the traditional techniques, are given below.

FIG. 1—Cross sectional view of the diaphragm-piston spring brake actuator with external breather tube produced in the prior art

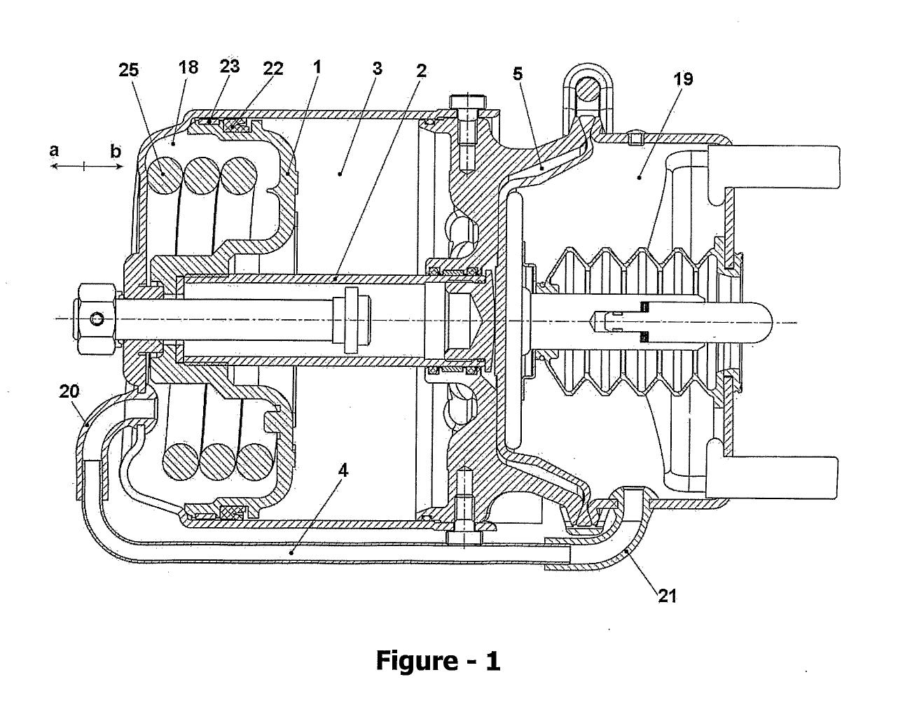

FIG. 2—Cross sectional view of the diaphragm-piston spring brake actuator having the internal ventilation system that has been the subject for the Patent Application No. TR 2002 00761 and PCT Application No. WO 03/080417 A1

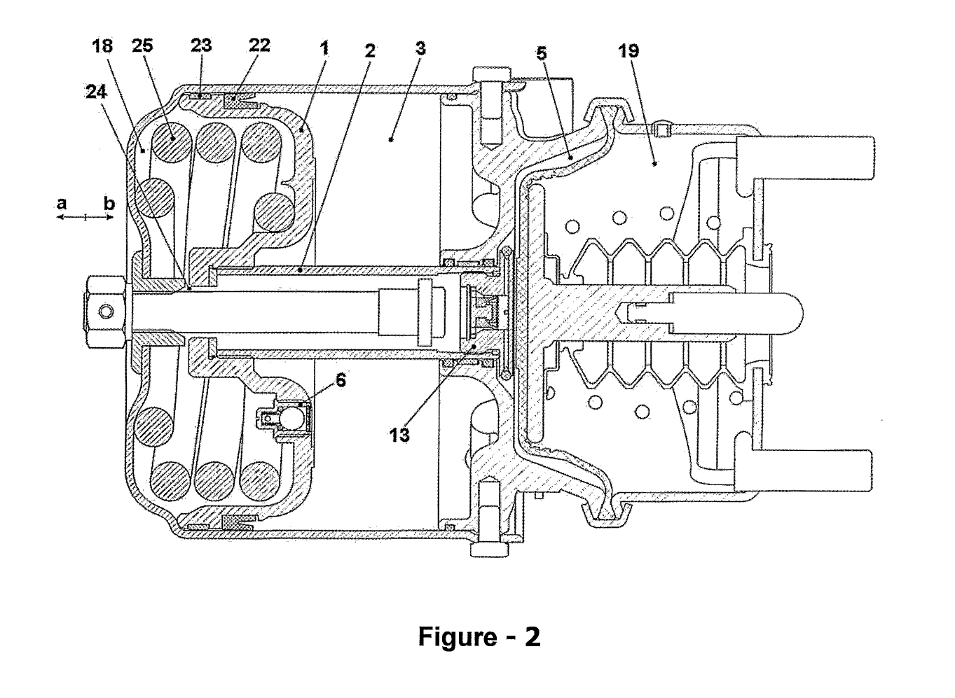

FIG. 3—Cross sectional view of the plug within the internal ventilation system that has been the subject for the Patent Application No. TR 2002 00761 and PCT Application No. WO 03/080417 A1

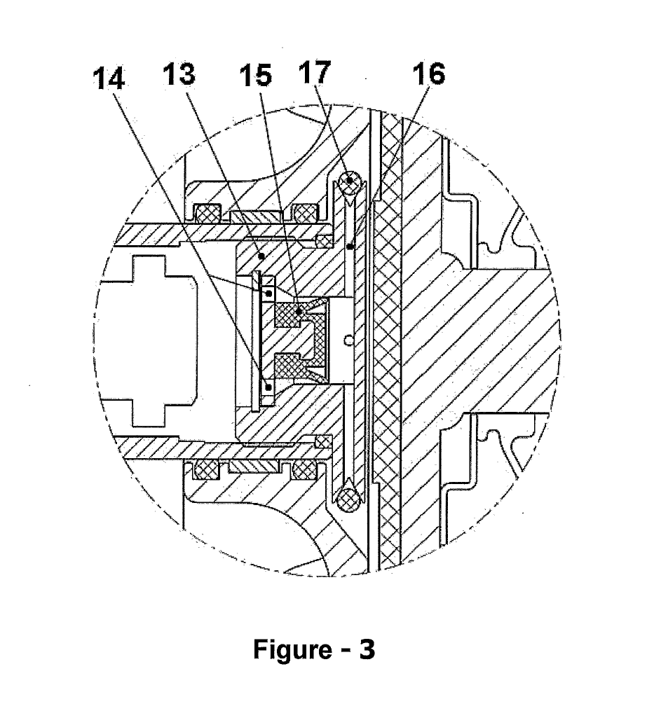

FIG. 4—Cross sectional view of the valve piece within the internal ventilation system that has been the subject for the Patent Application No. TR 2002 00761 and PCT Application No. WO 03/080417 A1

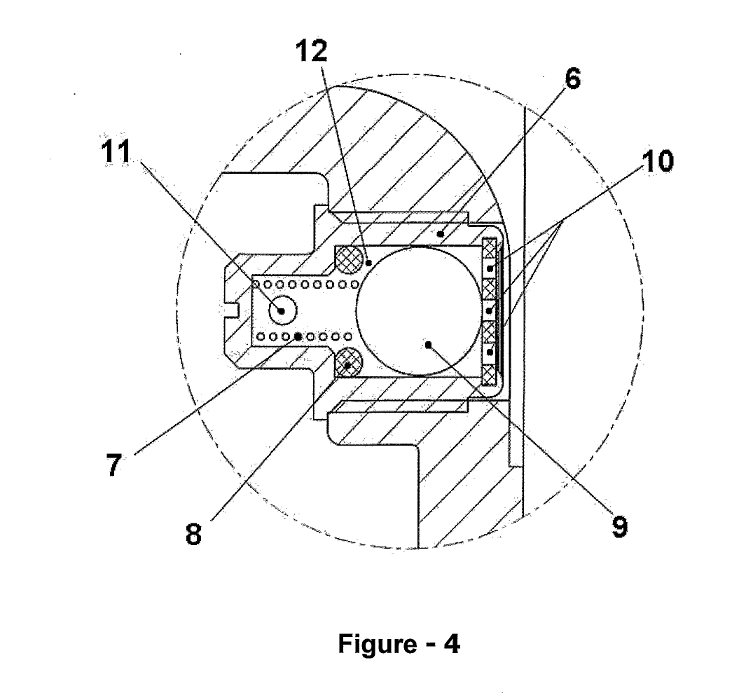

FIG. 5—Cross sectional view of the diaphragm-piston spring brake actuator having the internal ventilation system and being the subject of this invention

FIG. 6—Cross sectional view of the plug within the ventilation system that is the subject of this invention

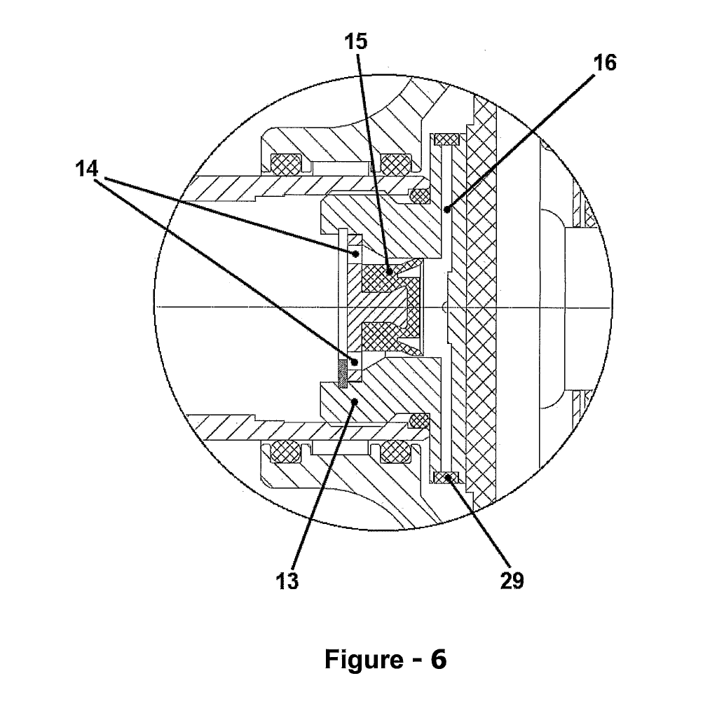

FIG. 7—Cross sectional view of the valve piece within the internal ventilation system that is the subject of this invention.

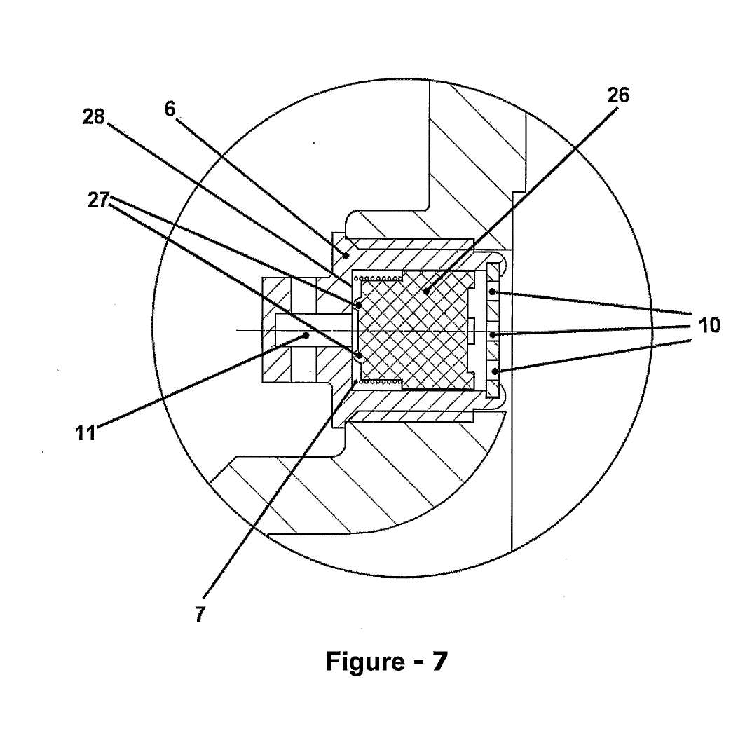

### BRIEF DESCRIPTION OF THE INVENTION

This invention is related to the internal ventilation system that is used in the diaphragm-piston spring brake actuators. Thanks to the said system, the factors such as dust, dirt, stone and moisture are avoided to enter into the back part of the piston in order not to affect the operation of the actuator.

In general, the system comprised two valves which are balancing the vacuum and excessive pressure at the back part of the piston. One of these valves is installed on the piston; and the other is integrated into the plug. The function of the valve placed on the piston is to ensure the balance of the vacuum pressure; and of the valve integrated into the plug is to balance the excessive pressure. This designed system allows the park chamber being affected by the environmental conditions at the lowest level.

An internal ventilation system developed for the diaphragm-piston spring brake actuators produced by our firm is also disclosed in the Patent Application No. TR 2002 00761 U and PCT Application No. WO 03/080417 A1. The internal ventilation system the references of which are mentioned below and the system that is the subject of the invention principally operate on the basis of the same logic. The internal ventilation system that is the subject of this invention has been transformed into a more sound and reliable structure.

### DESCRIPTION OF THE PARTS-SECTIONS-OF THE INVENTION

The description of the parts-sections-components which are covered in the figures that are prepared in order to better explain the diaphragm-piston spring brake actuator, which has been developed with this invention, are separately numbered and given below. The definition of each part corresponding to these numbers is provided below.
1. Aluminum Piston
2. Aluminum Pipe
3. Park Chamber
4. Breather Tube (External Ventilation Tube)
5. Service Chamber
6. Piston Valve
7. Spring
8. O-Ring
9. Ball
10. Outlet air openings
11. Inlet air openings
12. Air transition space
13. Internal ventilation plug
14. Air inlet holes
15. Pneumatic sealing (Nutring)
16. Air outlet channels
17. O-Ring
18. Back part of the piston
19. Atmospheric area
20. Rubber elbow
21. Rubber elbow
22. Sealing member
23. Sliding and bearing ring
24. Air transition aperture
25. Emergency Spring
26. Valve
27. Sealing lip
28. Piston Valve Sealing Surface
29. Square or rectangular sectional sealing ring

### DETAILED DESCRIPTION OF THE INVENTION

The back part of the piston (18) is totally isolated from the atmosphere by using the internal ventilation system; and therefore the penetrating of contaminants to the actuator is prevented in the internally ventilated diaphragm-piston spring brake actuator that is developed through this invention. Therefore, the probability of these contaminants to breakdown the actuator is eliminated.

The internally ventilated diaphragm-piston spring brake actuator, which is developed through this invention, is basically comprised by an aluminum piston (1), an aluminum pipe (2), a park chamber (3), a service chamber (5), a piston valve (6), a piston valve spring (7), a valve (26), sealing lips of the valve (27), sealing surface of piston valve (28), inlet air openings (11), air transition space (12), plug (13), air inlet openings (14), pneumatic sealing (15), outlet channel (16), square or rectangle sectional sealing member (29).

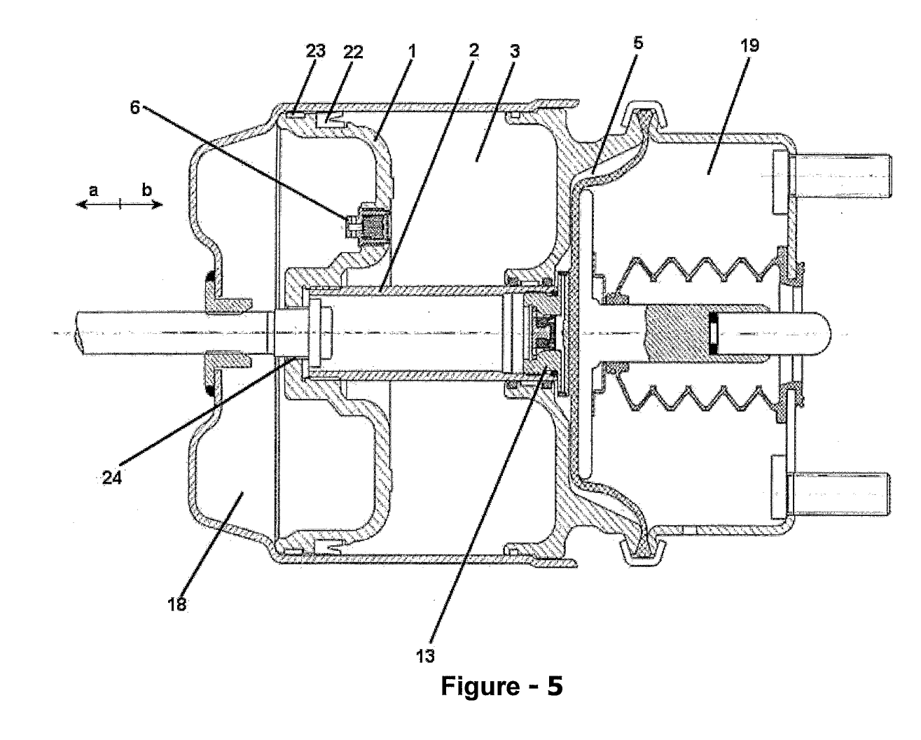

Different from the designs in the Patent Application No. TR 2002 00761 U and PCT Application No. WO 03/080417 A1 which are related to the internal breather plug, steel ball (9) and o-ring (8) are not present in piston valve (6) in this invention. Instead of these two parts (8, 9) a single component called valve (26) is designed, which also undertakes the sealing function. As shown in FIG. 5, just like o-ring (8) the valve (26) also has sealing lips (27). As soon as the compressed air begin to fill the park chamber (3), the valve (26) overcomes the spring (7) force and yet, its lips are (27) seated on the sealing surface of piston valve (28). Hence, sealing is maintained.

On the other hand, another variety is in the plug (13) section. Other than the designs in the TR 2002 00761 U numbered patent application and the WO 03/080417 A1 numbered PCT application, in this invention; in order to prevent air flow from the service chamber (5) to the park chamber (3), square or rectangle sectional sealing components (29) are used instead of o-ring (17). The o-ring (17) that is used in the prior designs is able to maintain the said sealing; still they cover the outlet channels (16) with a small surface area. Consequently, in order to increase security factors of the design that is the subject of the invention, square or rectangular sectioned sealing member (29) having larger surface area is used instead of o-ring (17).

In the following description of the invention, aluminum piston (1) and connected aluminum pipe (2) can move as beared in hollows. This system will be hereinafter called as piston briefly.

By the influx of the air into the park chamber (3), the park chamber (3) starts to be filled with the compressed air received from the air tanks of the vehicle. In this case, the valve (26) within the piston valve (6) compress the spring (7) by the effect of the pressure air; and its lips (27) seats on the sealing surface (28) of the piston valve. Hence, it is ensured that the piston valve (6) is closed and the sealing is maintained. The piston (1) moves in (a) direction due to the pressure created in the park chamber (3); and results in the compress of the air at the back part (18) of the piston. Compressed air passes through the air transition aperture (24); and reaches at the plug (13). The air enters into the plug (13) through the inlet holes (14); and arrives at the outlet channel (16) by opening the pneumatic sealing (15). Compressed air opens the square or rectangular sectioned sealing ring (29) and releases into the service chamber (5). Meanwhile, as the service chamber (5) is open to the atmosphere through the valves which differ from system to system, the compressed air is also released to the atmosphere.

As the air in the park chamber (3) is released by the shifting of the vehicle into the parking condition, the piston (1) moves in (b) direction by the force of the emergency spring (25); and results in the formation of the partial vacuum at the back part (18) of the piston. The said vacuum is opened to the atmosphere by means of the piston valve (6). In other words, the pressure that is effective on the valve (26) decreases down to the atmospheric pressure rapidly by the release of the air in the park chamber (3). Simultaneously, the valve (26) is moved by the force created by the compressed spring (7) and its lips (27) remove from the sealing surface (28) of the piston valve. The air absorbed through the air transition space (12) that is formed thereafter ensures the back part (18) of the piston to achieve the atmospheric pressure.

The internally ventilated diaphragm-piston spring brake actuator that is developed by this invention has avoided the leakage of the dirt, dust, water and corrosives which enter into the back part (18) of the piston through the openings caused by dislocation and rupture of the breather tube (4) because of several reasons and by the rubber elbows (20, 21); are absorbed inside by the movement of the piston (1) in (b) direction into the actuator. Thus, it will be prevented corrosion and oxidation of the emergency spring (25) and in the actuator; and avoided the sealing members (22) and the bearing ring (23) from being worn out and losing their functionality.

1. An internally ventilated diaphragm-piston spring brake actuator comprising an aluminum piston, an aluminum pipe, a park chamber, a service chamber, a piston valve located within the aluminum piston, the piston valve further comprising a piston valve spring, inlet air openings and an air transition space, the piston spring break actuator further comprising a plug, plurality of air inlet holes, a pneumatic sealing, and outlet channels the piston valve comprises a piston provided with sealing lips, cooperating with a sealing surface and in that a square or rectangular sectioned sealing member for the outlet channels is provided.

2. Internally ventilated diaphragm-piston spring brake actuator according to claim 1, wherein the piston is existing in the piston valve instead of a steel ball and an O-ring.

3. Internally ventilated diaphragm-piston spring brake actuator according to claim 1, wherein the piston has lips which are in the form of O-ring and ensure the proper sealing.

4. Internally ventilated diaphragm-piston spring brake actuator according to claim 2, wherein the piston has lips which are in the form of O-ring and ensure the proper sealing.

5. Internally ventilated diaphragm-piston spring brake actuator according to claim 1 wherein a square or rectangular sectioned sealing member with a larger sectional area is used in order to increase the safety.

6. Internally ventilated diaphragm-piston spring brake actuator according to claim 2 wherein a square or rectangular sectioned sealing member with a larger sectional area is used in order to increase the safety.

7. Internally ventilated diaphragm-piston spring brake actuator according to claim 3 wherein a square or rectangular sectioned sealing member with a larger sectional area is used in order to increase the safety.

8. Internally ventilated diaphragm-piston spring brake actuator according to claim 4 wherein a square or rectangular sectioned sealing member with a larger sectional area is used in order to increase the safety.

9. Internally ventilated diaphragm-piston spring brake actuator according to claim 1, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

10. Internally ventilated diaphragm-piston spring brake actuator according to claim 2, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

11. Internally ventilated diaphragm-piston spring brake actuator according to claim 3, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

12. Internally ventilated diaphragm-piston spring brake actuator according to claim 4, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

13. Internally ventilated diaphragm-piston spring brake actuator according to claim 5, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

14. Internally ventilated diaphragm-piston spring brake actuator according to claim 6, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

15. Internally ventilated diaphragm-piston spring brake actuator according to claim 7, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

16. Internally ventilated diaphragm-piston spring brake actuator according to claim 8, wherein the park chamber is filled with the pressure pressurized air from the air tanks of the vehicle by the influx of the air into the park chamber in order to ensure the sealing, the piston within the piston valve compresses the spring by the effect of the pressurized air and its lips on the sealing surface of the piston valve; and the piston valve is closed and at the same time.

17. Internally ventilated diaphragm-piston spring brake actuator according to claim 1, 2, 3, 4, 5, 6, 7, 8, 9, 10, 11, 12, 13, 14, 15 or 16 wherein the aluminum piston (1) moves in the direction (b) by the force of the emergency spring; and this movement causes partial vacuum at the back side of the piston; and the vacuum is opened to the atmosphere by means of the piston valve as the air in the park chamber is removed by the shifting of the vehicle into the parking condition.

18. Internally ventilated diaphragm-piston spring brake actuator according to claim 1, 2, 3, 4, 5, 6, 7, 8, 9, 10, 11, 12, 13, 14, 15 or 16 wherein the effective pressure applied on the valve piston decreases down to the atmospheric pressure rapidly by the release of the air in the park chamber; simultaneously, the piston is moved by the force created by the compressed spring and its lips remove from the sealing surface of the piston valve located within the aluminum piston and the air absorbed through the air transition space that is formed thereafter ensures the back part of the piston to reach at the atmospheric pressure, wherein the aluminum piston moves in the direction (b) by the force of the emergency spring; and this movement causes partial vacuum at the back side of the piston; and the vacuum is opened to the atmosphere by means of the piston valve as the air in the park chamber is removed by the shifting of the vehicle into the parking condition.
